(19) United States
(12) Patent Application Publication
(10) Pub. No.: US 2011/0267274 A1
(43) Pub. Date: Nov. 3, 2011

(54) KEYPAD

(76) Inventor: Igal Shusteri, Jeruselam (IL)

(21) Appl. No.: 13/144,089

(22) PCT Filed: Jan. 13, 2010
(86) PCT No.: PCT/IL2010/000034

§ 371 Date: Jul. 12, 2011

(30) Foreign Application Priority Data
Jan. 13, 2009 (IL) 196485
Sep. 6, 2009 (IL) 200765

(51) Int. Cl. G06F 3/02

(52) U.S. Cl. 345/168

(57) ABSTRACT

A keypad including an elastic sheet for disposing on a touch screen, the sheet including at least one key member shaped to define a space within the key member for providing tactile feedback when the key member is depressed and contacts the touch screen and a mounting element, for mounting the elastic sheet on the touch screen, coupled to the elastic sheet.

### FIELD OF THE INVENTION

The present invention relates to a keypad, in general and, in particular, to a keypad for touch screens.

### BACKGROUND OF THE INVENTION

A touch screen is a display that can detect the presence and location of a touch made on the display surface. The touch may be a finger touch or hand touch, or a touch by any other object, such as a stylus. The touch screen enables one to directly interact with data displayed on the screen, without requiring any intermediate device, such as a mouse or a keypad. Touch screens are incorporated in a variety of digital appliances, such as personal digital assistants (PDA), Tablet PCs, satellite navigation devices, mobile phones, and video games.

One example of a touch screen is a resistive touch screen. A resistive touch screen panel generally includes two transparent conductive layers separated by a narrow gap. The layers are disposed on a monitor displaying data. When an object, such as a finger, presses down on a point on the panel's outer surface, the two layers become connected at that point. This causes a change in the electrical current, which is registered as a touch event and sent to the controller for processing.

Another example of a touch screen is a capacitive touch screen. A capacitive touch screen panel includes a transparent layer that stores electrical charge, such as indium tin oxide. The transparent layer is disposed on a monitor displaying data. When a user touches the transparent layer with his or her finger, some of the charge is transferred to the user, so the charge on the capacitive layer decreases. This decrease is measured in circuits located at each corner of the monitor. A computer calculates, from the relative differences in charge at each corner, exactly where the touch event took place. The capacitive touch screen technology is used in a wide range of applications, including point-of-sale systems, industrial controls, and public information kiosks. Unlike the resistive touch screens, the capacitive touch screen only responds to a touch by a conductive material, and thus, does not work, for example, with a gloved hand.

There are known other technologies utilized in touch screens, one of which is surface acoustic wave (SAW) technology. SAW technology uses ultrasonic waves that pass over the touch screen panel. When the panel is touched, a portion of the wave is absorbed. This change in the ultrasonic waves registers the position of the touch event and sends this information to the controller for processing. Deficiencies of SAW touch screens include difficulty of use in winter when wearing gloves, or when used by old people.

However, conventional touch screens are unable to supply the confirmation that the tactile feel of buttons and mechanical controls provides. In order to overcome this problem, some systems include an audio signal, which sounds upon a touch on the touch screen. Other systems generate a vibration signal upon a touch on the touch screen. The vibration signal is particularly useful in environments in which audio cues are inappropriate or difficult to hear.

However, these systems do not provide a tactile sensation that resembles pressing on a mechanical button. In addition, these systems require a special technology which must be designed as an integral part of the touch screen.

Accordingly, there is a long felt need for an apparatus which creates a tactile sensation when using a touch screen, and it would be very desirable to have such apparatus which is low cost and can be easily removed.

### SUMMARY OF THE INVENTION

There is provided according to the present invention a keypad including an elastic sheet for disposing on a touch screen. The sheet includes at least one key member shaped to define a space within the key member for providing tactile feedback when the key member is depressed and contacts the touch screen. The keypad further includes a mounting element, for mounting the elastic sheet on the touch screen, coupled to the elastic sheet.

According to a further embodiment of the invention, the mounting element includes a static cling sheet coupled to the elastic sheet for mounting the elastic sheet on the touch screen. According to one embodiment of the invention, there is provided a keypad including an elastic sheet forming a single key member for engaging a touch screen, and a mounting element for mounting the key member on a finger of a user.

There is further provided according to the present invention a method for forming a keypad. The method includes configuring, from an elastic sheet, at least one key member shaped to define a space within the key member for providing tactile feedback when the key member is depressed and contacts the touch screen. The method further includes coupling a mounting element to the elastic sheet.

There is also provided, according to the invention, a keypad including an elastic sheet forming a single key member for engaging a touch screen, the key member being shaped to define a space within the key member for providing tactile feedback, and a mounting element for mounting the key member on a finger of a user.

### BRIEF DESCRIPTION OF THE DRAWINGS

The present invention will be further understood and appreciated from the following detailed description taken in conjunction with the drawings in which:

FIG. 1 is a schematic, top view illustration of a keypad constructed and operative in accordance with one embodiment of the present invention;

FIG. 2 is an exploded illustration of the touch screen keypad of FIG. 1;

FIG. 3 is a top view illustration of the touch screen keypad of FIG. 1 mounted on a handheld device;

FIG. 4a is a side sectional view of a key in a touch screen keypad constructed and operative in accordance with one embodiment of the present invention;

FIG. 4b is a side sectional view of a key in a touch screen keypad constructed and operative in accordance with another embodiment of the present invention;

FIG. 4c is a side sectional view of a key in a touch screen keypad constructed and operative in accordance with further embodiment of the present invention;

FIG. 4d is a side sectional view of a key in a touch screen keypad constructed and operative in accordance with another embodiment of the present invention;

FIG. 5 is a side sectional view of a touch screen keypad mounted on a touch screen;

FIG. 6 is a top perspective view illustration of a touch screen keypad constructed and operative in accordance with another embodiment of the present invention;

FIG. 7 is a top view illustration of the touch screen keypad of FIG. 6;

FIG. 8 is a partial cut-away bottom perspective view illustration of the touch screen keypad of FIG. 6;

FIG. 9 is a schematic illustration of a person using a handheld device having a touch screen keypad of FIG. 6 mounted thereon;

FIG. 10a is a perspective view of a touch screen keypad mounted in accordance with one embodiment of the present invention on a handheld device;

FIG. 10b is a perspective view of a touch screen keypad mounted in accordance with another embodiment of the present invention on a handheld device;

FIG. 10c is a perspective view of a touch screen keypad mounted in accordance with another embodiment of the present invention on a handheld device;

FIG. 10d is a perspective view of a touch screen keypad mounted in accordance with another embodiment of the present invention on a handheld device;

FIG. 10e is a perspective view of a touch screen keypad in accordance with another embodiment of the present invention mounted on a handheld device constructed and operative;

FIG. 11 is a perspective view illustration of a keypad constructed and operative in accordance with one embodiment of the present invention;

FIG. 12a is a perspective view illustration of a keypad constructed and operative in accordance with a further embodiment of the present invention;

FIG. 12b is a perspective view illustration of a keypad constructed and operative in accordance with a further embodiment of the present invention;

FIG. 13 is a perspective view illustration of a keypad constructed and operative in accordance with another embodiment of the present invention;

FIG. 14a is a perspective front view illustration of a keypad constructed and operative in accordance with one embodiment of the present invention; and,

FIG. 14b is a perspective view illustration of the keypad of FIG. 14a in use.

### DETAILED DESCRIPTION OF THE INVENTION

The present invention relates to a keypad covering at least a portion of a touch screen, for providing a tactile interaction. The keypad includes an elastic sheet adapted to engage a portion of the touch screen. The sheet includes at least one key member shaped to define a space within the key member, for providing tactile feedback. In particular, a tactile sensation is created (typically, movement of the key member against mechanical resistance) as the key member is depressed against the touch screen and returns to its original shape. According to one embodiment, the outside surface of the elastic sheet is formed with a tactile texture. Preferably, the keypad is at least partially transparent, allowing the user to view the data displayed on the touch screen beneath it. According to one embodiment, the keypad further includes a mounting element for coupling the keypad to the touch screen.

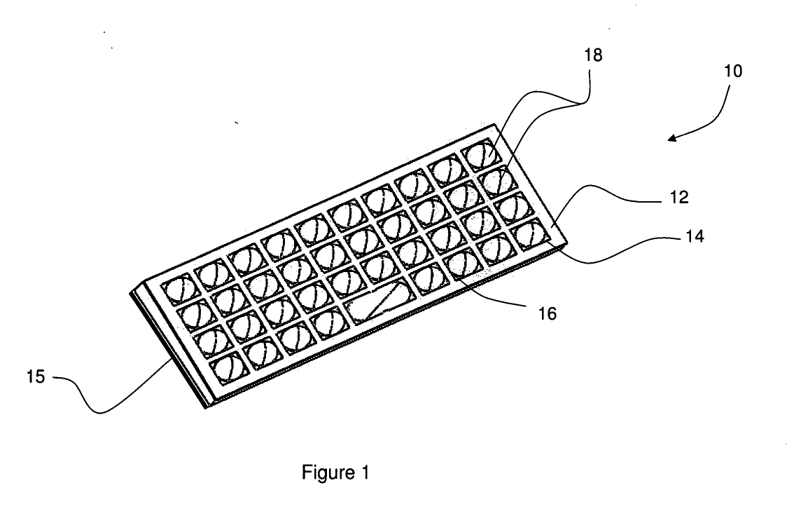

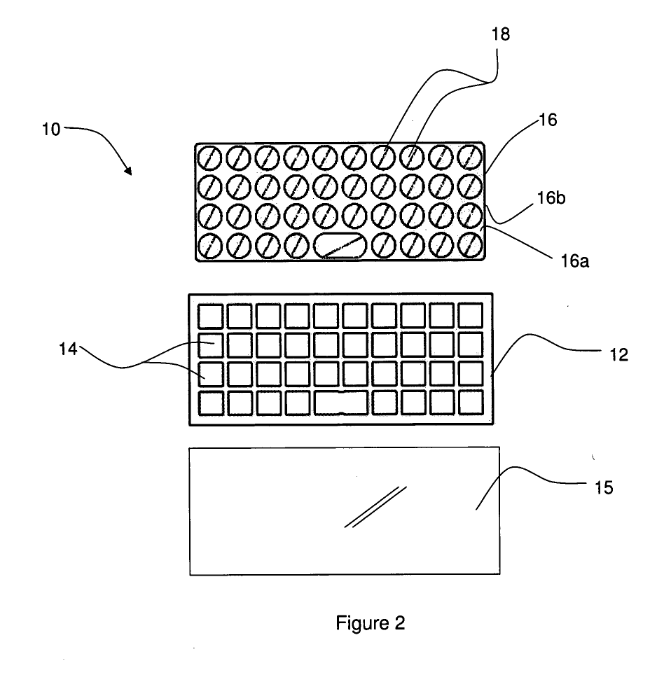

FIGS. 1 and 2 are a top view illustration and an exploded illustration, respectively, of a touch screen keypad 10 constructed and operative in accordance with one embodiment of the present invention. Keypad 10 includes a plate 12, having at least one aperture, and preferably having a plurality of apertures 14. Keypad 10 further includes an elastic sheet 16 having an upper surface 16a facing the user, and a lower surface 16b facing the touch screen. Upper surface 16a defines a plurality of key members 18, each key member includes a top portion and a wall portion which define a space. The elastic material of key members 18 permits depressing the top portion until it abuts the touch screen. Elastic sheet 16, according to one embodiment, is made of a conductive material, which is configured to activate the touch screen when key member 18 depressed by the user's finger. One example of a conductive elastic material is polyvinyl chloride (PVC), whose conductivity is similar to the conductivity of a human finger.

Plate 12 is coupled to upper surface 16a of elastic surface 16, and each of key members 18 is disposed in one of apertures 14. Plate 12 provides elastic sheet 16 with firmness, and helps maintain keypad 10 in position on the touch screen.

According to another embodiment of the invention, plate 12 is coupled to lower surface 16b, and each of key members 18 is disposed coaxially with one of apertures 14. Plate 12, according to this embodiment, provides an additional space between elastic sheet 16 and the touch screen for enabling a tactile feedback of the key member when depressed.

Coupling plate 12 to upper surface 16a or lower surface 16b of elastic surface may be carried out by various known methods, such as gluing, soldering etc.

Keypad 10 further includes a mounting element for mounting the elastic sheet and the plate on a touch screen. According to one embodiment of the invention, the mounting element may be a static cling sheet 15 for removably mounting elastic sheet 16 and plate 12 on a cellular phone touch screen. The static cling sheet 15 is made of a conductive material, such as PVC, or any other material, which carries static electricity. When plate 12 is disposed on top of elastic sheet 16, cling sheet 15 is coupled to the lower surface 16b of elastic sheet 16 for holding sheet 16 on the touch screen. When plate 12 is disposed underneath elastic surface 16, cling sheet 15 is coupled to the bottom of plate 12. Coupling cling sheet 15 to elastic sheet 16 or to the bottom of plate 12 may carried out by various known methods, such as gluing, soldering etc.

It will be appreciated that the static cling sheet is transparent or translucent, and it is configured to properly function with capacitive touch screens to allow activation of a virtual key on the touch screen. Alternatively, in the event that the cling sheet is not transparent it may be adapted for coupling only to portions of the bottom of keypad 10, for example, strips of static cling material coupled to portions of plate 12, so as to allow the user to view the virtual keys, and to allow lower surface 16b to contact the touch screen when depressed.

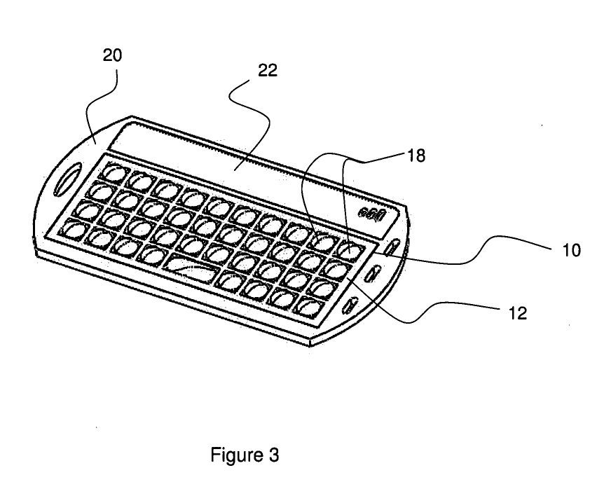

FIG. 3 is a top view illustration of touch screen keypad 10 of FIG. 1 mounted on a touch screen of a cellular phone. Keypad 10 is mounted on a cellular phone 20 having a touch screen 22 by means of a mounting element (not shown). Keypad 10, according to this embodiment, covers only a portion of touch screen 22, preferably the portion displaying a virtual keyboard. According to this embodiment, each key member 18 on keypad 10 is disposed over a spot on touch screen 22 displaying one virtual key. In this way, each key member 18 serves as a mechanical key associated with a virtual key on touch screen 22. Keypad 10 is preferably at least partially transparent, allowing the user to view the virtual keyboard displayed on touch screen 22 through the keypad. Alternatively, the character associated with each key on the virtual keyboard may be printed directly on key member 18 disposed thereabove.

Pressing on the top portion of one of key members 18 causes the corresponding portion of lower surface 16b to contact touch screen 22. When touch screen 22 is a resistive touch screen, lower surface 16b pressing on the touch screen causes an electric contact between the two conductive layers inside the touch screen. When touch screen 22 is a capacitive touch screen, lower surface 16b touching a spot on the touch screen discharges the electric charge on that spot on the touch screen. In the latter case, elastic sheet 16 must be electrically conductive, preferably having conductivity characteristics similar to those of the human finger. It will be appreciated that keypad 10 may be configured to function compatibly with a touch screen 22 which is based on other technologies, or a combination thereof.

It will be further appreciated that keypad 10 may be placed on a different portion of touch screen 22, for example, for providing a tactile sensation when clicking on icons on a touch screen, or may be completely removed.

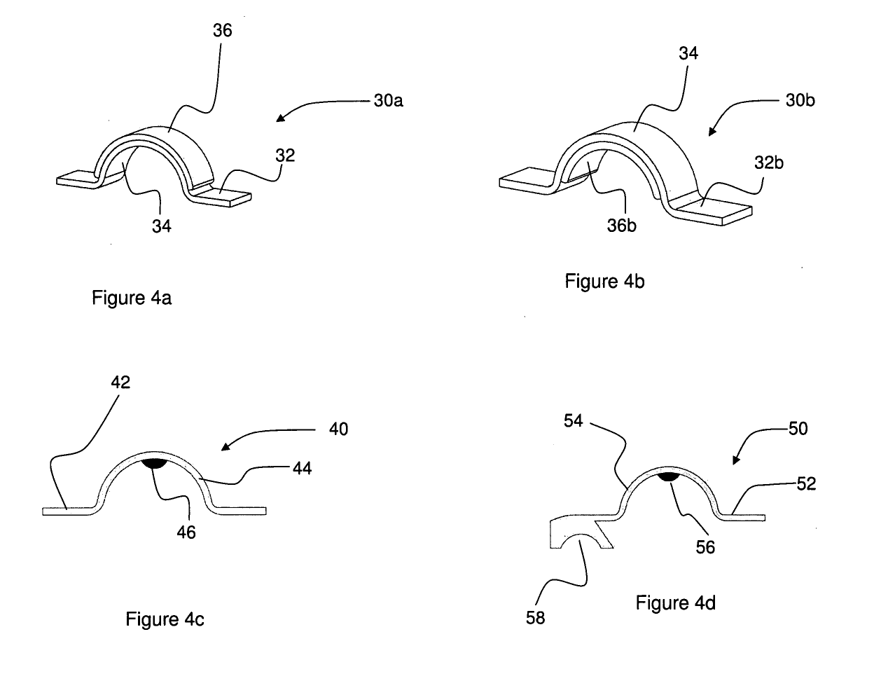

FIG. 4a is a side sectional view of a key member forming part of a touch screen keypad, according to one embodiment of the invention. Key member 30a includes an elastic layer 32 forming a dome 34 defining a space between the elastic layer 32 and the touch screen. Key member 30a further includes a semi-rigid shell 36a seated on dome 34 which is configured to snap when depressed, in order to provide a tactile sensation, and to snap back to its original shape when released. Shell 36a can be a cap covering dome 34 or may be a band over the apex of dome 34. Shell 36a is placed on dome 34 and provides elastic layer 32 with a firm structure. Shell 36a may be made of a transparent material and, according to one embodiment, may be configured to magnify the icons or virtual keys displayed on the touch screen.

According to another embodiment, a shell may be disposed underneath dome 34, as can be seen in FIG. 4b, illustrating a key member 30b having a shell 36b. It will be appreciated that elastic layer 32, and/or shell 36b, will have conductive characteristics, if the keypad is to be used on a capacitive touch screen.

FIG. 4c is a side sectional view of a key member, according to another embodiment of the present invention, forming part of a touch screen keypad. Key member 40 includes an elastic layer 42 defining a dome 44. Key member 40 further includes a rigid contact element 46, here illustrated as a small ball, disposed underneath dome 44. Contact element 46 is particularly important when key member 40 is used with a resistive touch screen, which requires pressure to create contact between the two conductive layers inside the resistive touch screen.

FIG. 4d is a side sectional view of a key forming a part of touch screen keypad according to a further embodiment of the invention. Key member 50 is substantially the same as key member 40 of FIG. 4c and includes an elastic layer 52 defining a dome 54 with a contact element 56 therein. Adjacent key member 50 there is provided a mounting element, here illustrated as a suction mount 58, for removably attaching the keypad to a touch screen. Suction mount 58 is pressed onto the touch screen, thereby creating a vacuum which maintains the keypad in place. It will be appreciated that suction mount 58 may be replaced with any other mounting element.

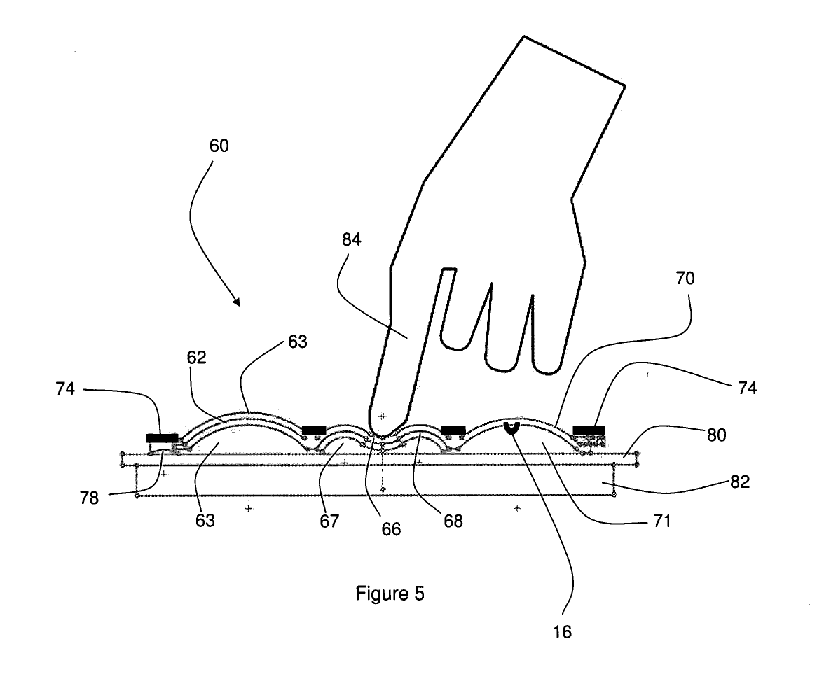

FIG. 5 is a side sectional view of a touch screen keypad 60 including an elastic layer 65 defining various key members, according to different embodiments of the invention, mounted on a touch screen 80. Keypad 60 includes a first key member 62 having an outer shell 64, substantially as described with regard to key member 30a of FIG. 4a. Keypad 60 further includes a second key member 66 having an inner shell 68, substantially as described with regard to key member 30b of FIG. 4b. Keypad 60 further includes a third key member 70 having a rigid contact element 72, substantially as described with regard to key member 40 of FIG. 4c. For the sake of convenience, keypad 60 is illustrated here as having keys 62, 66 and 70, which differ from one another, as described above. Typically however, keypad 60 includes a set of keys, all having a similar structure, for example, the structure of one of keys 62, 66 or 70.

Keypad 60 further includes an upper plate 74a providing keypad 60 with stability and assisting the user in maintaining keypad 70 in place. Upper plate 74a is disposed around keys 62, 66, and 70, precluding the movement of one key when an adjacent key is pressed, and thus avoiding unintentional activation of a virtual key on touch screen 82. Preferably, keypad 60 further includes a bottom plate 74b mounted between and beneath keys 62, 66 and 70. Bottom plate 74b separates keys 62, 66 and 70 from touch screen 80 thus, precluding undesired contact with touch screen 80. Elastic layer 65 defining keys 62, 66, and 70 is clamped between upper plate 74a and bottom plate 74b, thereby retaining the keys in place on the touch screen. In addition, keypad 60 includes suction mounts 78, for attaching keypad 60 to a touch screen 80 for a display device 82.

As illustrated in FIG. 5, when a user depresses key 66, i.e. using a finger 84, shell 68 is pressed against touch screen 80. Shell 68 resists the pressure applied by finger 84, and provides the user with tactile feedback. Shell 68 pressing on touch screen 80 functions as a finger pressing substitute. It will be appreciated that the surface contacting the touch screen, such as shell 68, may be made of conductive material configured to activate a capacitive touch screen. Alternatively, for example when touch screen 80 is a resistive touch screen, shell 68 may be provided with the firmness necessary for creating contact between the conductive layers of the touch screen.

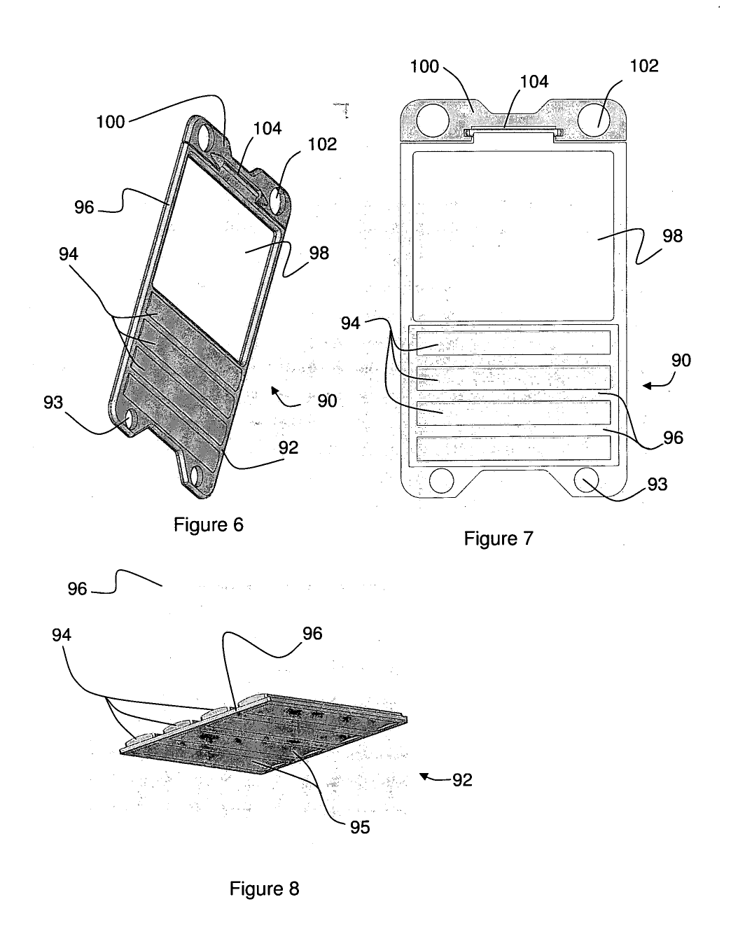

FIGS. 6 and 7 are a perspective illustration and a top view illustration, respectively, of a touch screen panel 90 constructed and operative in accordance with another embodiment of the present invention. Touch screen panel 90 includes a keypad portion 92 having a plurality of elongated keys 94, which are made of an elastic material. Preferably, each elongated key 94 is configured to cover a line of virtual keys displayed along the width of a touch screen. Alternatively, each elongated key 94 may be configured to cover a column of keys displayed along the length of a touch screen with a space between each key and the screen. Keypad portion 92 further includes keypad suction mounts 93, for coupling panel 90 to the touch screen. Panel 90 further includes a plate 96, preferably made of a rigid material. Plate 96 surrounds each one of elongated keys 94, providing keypad portion 92 with stability and precluding the movement of keypad portion 92. The immovability of keypad portion 92 is important, in particular, when one of elongated keys 94 is depressed, so as to avoid the unintentional activation of the wrong virtual key on the touch screen. According to this embodiment, plate 96 further defines a window portion 98, extending away from keypad portion 92. Window portion 98 may be configured to be disposed on portions of a touch screen which do not display a virtual keyboard.

Panel 90 further includes a mounting portion 100 having two suction mounts 102. Mounting portion 100 is coupled to window portion 98 by means of a hinge 104, which permits pivoting of window portion 98 and keypad portion 92 away from the touch screen.

Panel 90 is disposed on a touch screen in such a way that keypad portion 92 covers the virtual keyboard displayed on the touch screen, whereas other portions of the touch screen can be viewed through window portion 98. Panel 90 may be coupled to the touch screen by pressing suction mounts 102 and keypad suction mounts 93 onto the periphery of the touch screen. When the user wishes to use the touch screen without panel 90, he merely releases keypad suction mounts 93, and pivots keypad 92 and window portion 98 away from the touch screen. Mounting portion 100 can remain coupled by suction mounts 102 to the touch screen. Keypad suction mounts 93 may be smaller than suction mounts 102, and thus can be released easily, allowing the user to pivot keypad portion 92 away from the touch screen. Suction mounts 102, on the other hand, are intended to remain attached to the touch screen, so as to maintain mounting portion 100 in place. In this way, when the user wishes to make use of panel 90 again, he can pivot keypad portion 92 back to its original position on the touch screen, so that elongated keys 94 again cover the virtual keyboard displayed thereon. When the user wishes to completely remove panel 90, he releases suction mounts 102 as well, thereby detaching mounting portion 100. It will be appreciated that mounting portion 100 may be replaced with a mounting portion constituting an integral part of the handheld device.

FIG. 8 is a bottom perspective view of a keypad portion 92 of touch screen keypad 90 of FIGS. 6 and 7. Keypad portion 92 includes a plurality of elastic elongated keys 94, each surrounded by plate 96. Each elongated key 94 is convex and is configured to allow selective contact between the key and the touch screen disposed underneath, only when elongated key 94 is depressed. It will be appreciated that each elongated key 94 is made of an elastic material, ensuring that when one segment of elongated key 94 is depressed, contact between that segment and the touch screen is created, which can be felt by the user, whereas other segments of elongate key 94 are not in contact with the touch screen.

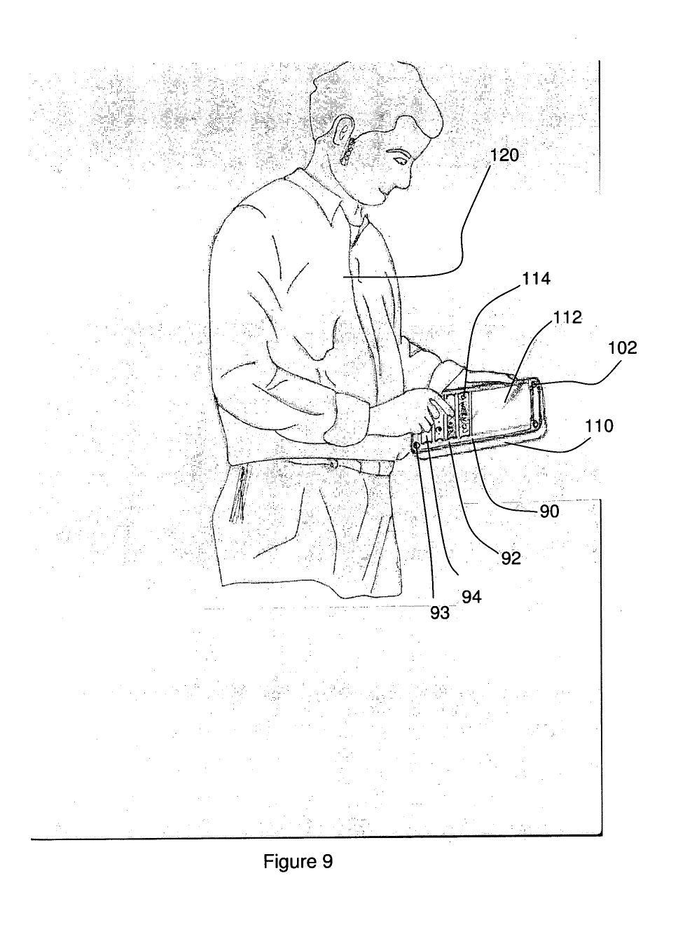

FIG. 9 is schematic illustration of a user 120 using a handheld device, such as an iPhone™, having the touch screen keypad 90 of FIG. 6 mounted thereon. Handheld device 110 includes a touch screen 112 displaying a set of virtual keys 114. Keypad 90 is mounted on handheld device 110 with suction mounts 102 and keypad suction mounts 93. Keypad portion 92 covers virtual keys 114 displayed on touch screen 112 in such a way that each elongated key 94 covers a line of virtual keys 114. Other portions of touch screen 112 may be viewed through window portion 98. User 120 depresses a segment of elongated key 94, which is disposed on top of one of virtual keys 114. As elongated key 94 is depressed, contact is created between the segment of key 94 being depressed and a spot on touch screen 112 associated with one virtual key 114. As a result, virtual key 114 is activated. Thus, activating virtual key 114 provides the user with tactile feedback associated with the process of depressing elongated key 94.

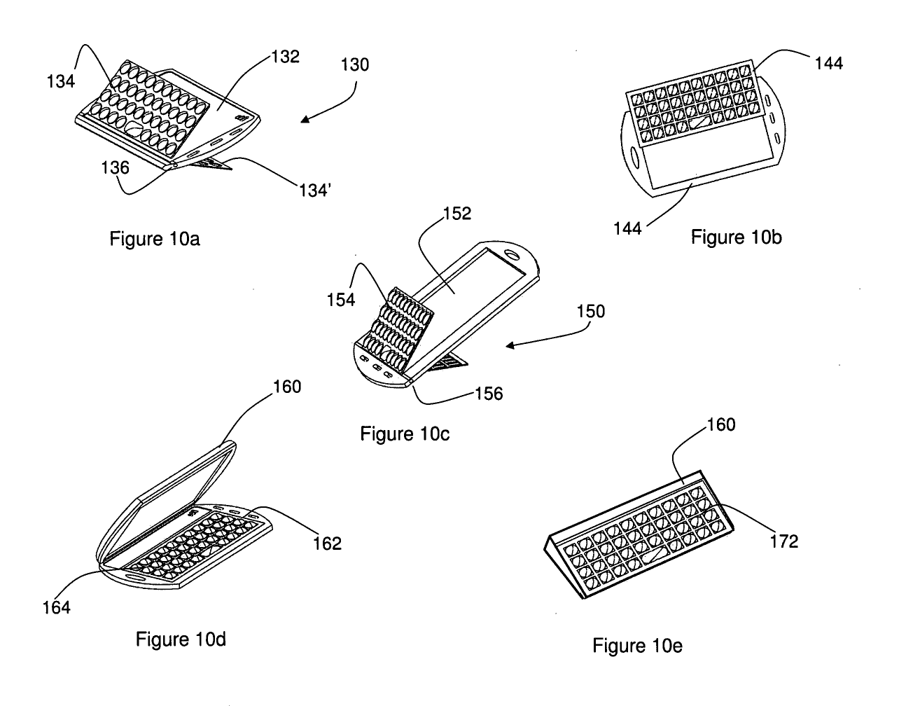

FIGS. 10a to 10e show various methods according to the invention, of coupling a touch screen keypad to a touch screen.

FIG. 10a is a perspective view of a handheld device 130 having a touch screen 132, and a touch screen keypad 134 mounted thereon. According to this embodiment, keypad 134 is disposed along the length of touch screen 132, and is configured to engage a horizontally disposed virtual keyboard in landscape orientation displayed thereon. Keypad 134 includes a hinge 136, which is coupled to handheld device 130, allowing the user to pivot keypad 134 onto and away from touch screen 132. Preferably, hinge 136 is coupled to the edge of handheld device 130, so as to allow pivoting keypad 134 to the front or the back side of handheld device 130, as indicated at reference numerals 134 and 134′. Preferably, hinge 136 is configured to permit pivoting of keypad 134 until it abuts the back side of handheld device 130, so as to allow the smooth use of handheld device 130, when the user is not using keypad 134.

According to FIG. 10b touch screen keypad 144 is slideably mounted on the handheld device 140.

FIG. 10c is a perspective view of a handheld device 150 having a touch screen 152. Handheld device 150 is substantially the same as handheld device 130 of FIG. 10a. According to this embodiment handheld device 150 includes a touch screen 152 displaying a vertical virtual keyboard in a portrait orientation. A touch screen keypad 154 is mounted on touch screen 152 and is configured to cover the portrait virtual keyboard displayed thereon. Keypad 154 includes a hinge 156, substantially the same as described in reference to hinge 136 of FIG. 10a.

In FIG. 10d, there is shown a laptop computer 160 with a touch screen keyboard 162 and a touch screen keypad 164 according to the invention mounted on keyboard 162.

FIG. 10e shows a schematic illustration of touch screen keyboard 170 which is used with a desktop computer (not shown). A touch screen keypad 172 is mounted on keyboard 170, so as to provide the user with tactile feedback similar to the feedback provided by a standard keyboard.

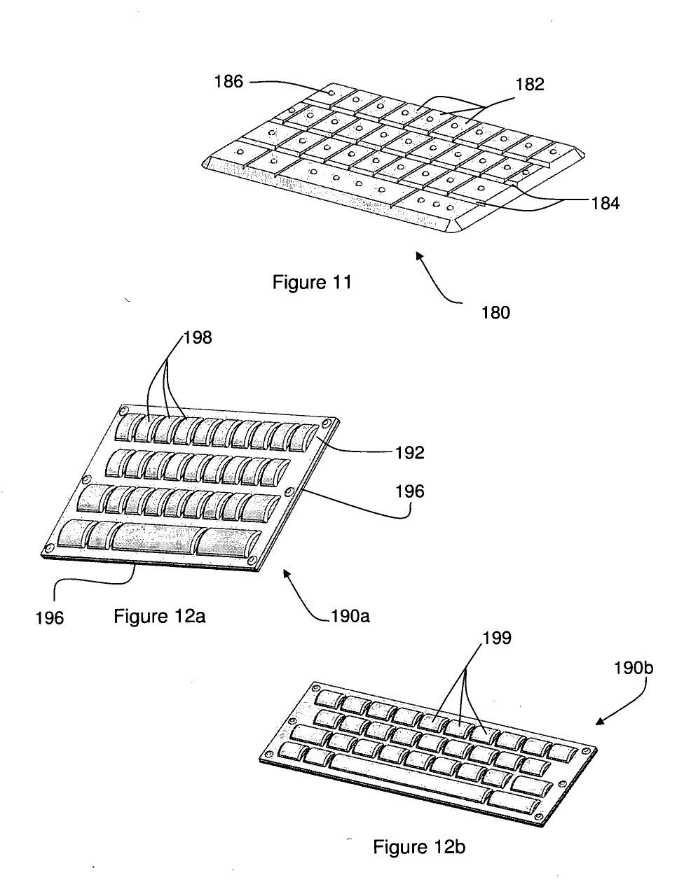

FIG. 11 shows a schematic illustration of touch screen keypad 180 adapted and configured according to one embodiment of the invention. Keypad 180 includes a plurality of key members 182 separated by a plurality of grooves 184. Each key member 182 includes a projection 186, here illustrated as a hemisphere. Projection 186 facilitates the depression of each key member 182 and assists the user in feeling the desired key member to be depressed. Keypad 180, according to this embodiment, includes a single surface, preferably made of a transparent conductive material. It will be appreciated that the elasticity of keypad 180 may be adapted to allow depression of one key member 182 without moving adjacent key members.

FIG. 12a is a schematic illustration of a keypad 190a constructed and operative in accordance with another embodiment of the invention. Keypad 190a includes an upper plate 192, a lower plate 194, and a conductive layer 196 clamped therebetween. Conductive layer 196 defines a plurality of key members 198 projecting through apertures in upper plate 192. Preferably, keypad 190a further includes coupling members 193 for coupling upper plate 192, lower plate 194, and conductive layer 196 together.

Keypad 190a is configured to engage a vertical virtual keyboard displayed on a touch screen in a portrait orientation. Alternatively, the keypad may be configured to engage a horizontally disposed virtual keyboard, such as keypad 190b, in landscape orientation shown in FIG. 12b. According to one embodiment, key members 199 defined on keypad 190b are wider than key member 198 defined on keypad 190a, in accordance with the width of the virtual keys beneath them.

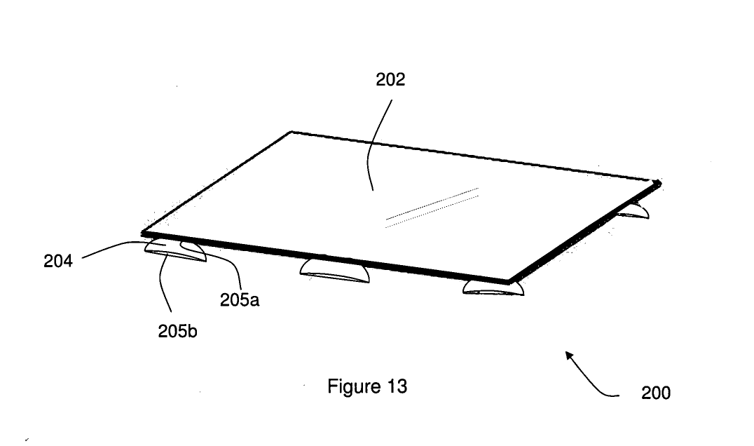

FIG. 13 is a schematic illustration of a keypad 200 constructed and operative in accordance with further embodiment of the invention. Keypad 200 includes an elastic panel 202, which is, preferably, a conductive transparent layer. Elastic panel 202, according to one embodiment, is a homogeneous surface, but alternatively may include a pattern, such as grooves defining keys. Keypad 200 further includes a plurality of domes 204 mounted underneath elastic panel 202, although not necessarily one dome in registration with each virtual key. Domes 204 are configured to snap when keypad 200 depressed, in order to provide a tactile sensation. According to the illustrated embodiment, the apex 205a of each dome 204 is coupled to elastic layer 202, and the base 205b is disposed on a touch screen panel or on a plate around a touch screen. Depressing a portion of elastic layer 202 and engagement of the virtual key on the touch screen, causes at least one dome 204 to be depressed, thus providing the user with tactile feedback. It will be appreciated that elastic panel 202 is elastic enough to allow pressing one portion thereof until contacting the touch screen, while other portions are not in contact with the touch screen, and thus only the desired virtual key is activated. Alternatively, base 205b may define a bottom layer closing the dome, defining a space within the key member between the apex 205a and the base 205b.

According to one embodiment keypad 200 may be coupled to a touch screen by means of a rubber band wrapped around the handheld device. When keypad 200 is used, elastic panel 202 can be inserted between the rubber band and the touch screen. When keypad 200 is removed, the rubber band may be removed or alternatively may be left on the handheld device.

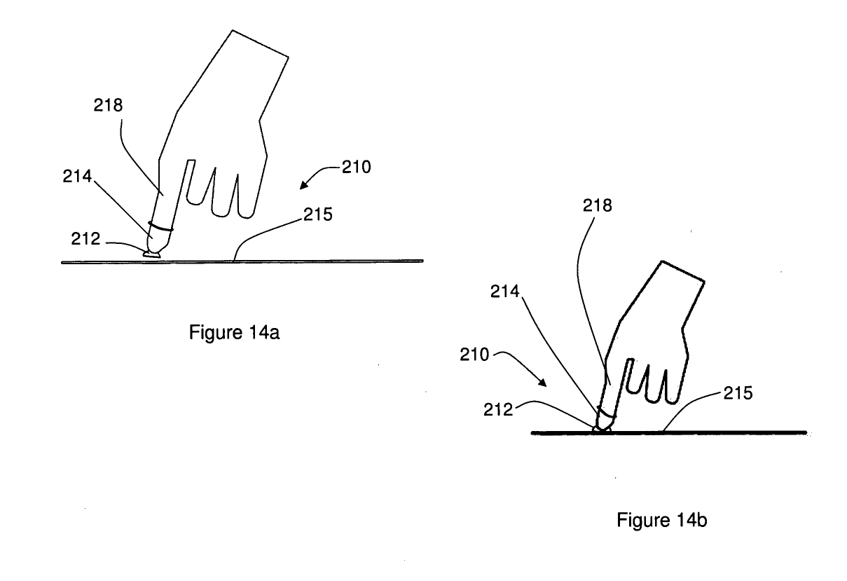

FIG. 14a is a front view illustration of a keypad 210 constructed and operative in accordance with one embodiment of the invention, in the form of a finger cover. Keypad 210 is made of an elastic sheet forming a single key member 212 for engaging a touch screen, and a mounting element 214 for mounting key member 212 on the finger 218 of a user. In the illustrated embodiment, mounting element 214 is a finger socket for mounting the key member on a finger 218. It will be appreciated that the finger socket can be the finger of a glove. Key member 212 is preferably shaped as a dome. Finger socket 214 is preferably made of an elastic material configured for removable mounting on any desired finger. Key member 212 is adapted to engage a touch screen panel when pressed by a finger in the finger socket. Preferably, dome-shaped key member 212 is configured to snap when depressed, in order to provide a tactile sensation. Alternatively, the mounting element may be a ring (not shown), a layer of adhesive material (not shown) for adhering to the skin on the user's finger and/or to his finger nail, or any other suitable means for mounting the key member on a finger of a user.

As shown in FIG. 14b, a user having a keypad 210 mounted on his finger 218 can activate a virtual key or icon displayed on a touch screen 215, by pressing key member 212 onto the desired spot on touch screen 215. As the user presses key member 212 onto touch screen 215, key member 212 is depressed until finger socket 214 contacts touch screen 215. As the user lifts finger 218 away from touch screen 215, dome 215 returns to its original shape.

It will be appreciated that when touch screen 215 is a capacitive touch screen, at least the tip of finger socket 214 is made of a conductive material, allowing electric coupling between touch screen 215 and the user's finger 218. In that case, key member 212, mounted on the tip of finger socket 212, may include an aperture permitting contact between finger socket 214 and touch screen 215. Alternately, both key member 212 and finger socket 214 can be made of conductive material, allowing the electric coupling with user's finger 218 and thereby permitting the discharge of touch screen 215.

While key member of the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A keypad comprising:
an elastic sheet for disposing on a touch screen, said sheet including at least one key member shaped to define a space within said key member for providing tactile feedback when said key member is depressed and contacts said touch screen; and
a mounting element coupled to said elastic sheet.

2. The keypad according to claim 1, wherein said key member defines a dome providing tactile feedback.

3. The keypad according to claim 1, further comprising a plate coupled to said elastic sheet.

4. The keypad according to claim 3, wherein said plate is coupled to an upper surface of said elastic sheet.

5. The keypad according to claim 3, wherein said plate is coupled to a lower surface of said elastic sheet.

6. The keypad according to claim 1, wherein said mounting element is a static cling sheet coupled to said elastic sheet.

7. The keypad according to claim 1, wherein said key member is an elongated key member providing selective contact with a selected virtual key therebeneath.

8. The keypad according to claim 2, wherein said key member further includes a shell on an outer surface of said dome.

9. The keypad according to claim 2, wherein said key member further includes a shell on an inner surface of said dome.

10. The keypad according to claim 8, wherein said shell is a semi-rigid shell.

11. The keypad according to claim 2, wherein said dome further includes a rigid contact member arranged to contact said touch screen.

12. The keypad according to claim 1, wherein said elastic sheet is formed of a conductive material.

13. The keypad according to claim 1, comprising a plurality of key members.

14. The keypad according to claim 1, wherein said mounting element includes an element for mounting the key member on a tip of a finger.

15. A method for forming a keypad, the method comprising:
configuring, from an elastic sheet, at least one key member shaped to define a space within said key member for providing tactile feedback when said key member is depressed and contacts said touch screen; and
coupling a mounting element to said elastic sheet.

16. A keypad comprising:
an elastic sheet forming a single key member for engaging a touch screen, said key member being shaped to define a space within said key member for providing tactile feedback; and
a mounting element for mounting said key member on a finger of a user.

17. The keypad according to claim 2, wherein said mounting element includes an element for mounting the key member on a tip of a finger.
